(19) United States
(12) Patent Application Publication
(10) Pub. No.: US 2025/0165737 A1
(43) Pub. Date: May 22, 2025

(54) Dynamic Auto-Focus Control for Image-Based Barcode Decoding

(71) Applicant: ZEBRA TECHNOLOGIES CORPORATION, Lincolnshire, IL (US)

(72) Inventors: Mayuresh Mahabala, Bangalore (IN); Arun Gupta, Bangalore (IN)

(21) Appl. No.: 18/514,714

(22) Filed: Nov. 20, 2023

(51) Int. Cl. G06K 7/14; G06K 7/10; H04N 23/61; H04N 23/67

(52) U.S. Cl. CPC G06K 7/1417; G06K 7/10722; H04N 23/61; H04N 23/675

(57) ABSTRACT

A method includes: capturing, via an image sensor of a computing device, a first image in a frame sequence using a first autofocus region having a first position; detecting a region of interest having a second position in the image, the region of interest containing a barcode; in response to receiving, at an autofocus controller, a failure to decode the region of interest, generating, by the autofocus controller, a second autofocus region based on the second position of the region of interest in the image, the second autofocus region configured for capturing a second image in the frame sequence via the image sensor.

### BACKGROUND

An image-based barcode scanner may capture an image depicting multiple barcodes, and attempt to decode each barcode in the image. Under some conditions, however, e.g., dependent on ambient light levels, the distance between the scanner and the barcodes, and the like, the scanner may fail to decode certain barcodes in the image.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a computing device for image-based barcode decoding.

FIG. 2 is a diagram illustrating an image including a barcode affected by sub-optimal focus settings.

FIG. 3 is a flowchart of a method of auto-focus control for image-based barcode decoding.

FIG. 4 is a diagram illustrating an example performance of blocks 305 and 310 of the method of FIG. 2.

FIG. 5 is a diagram illustrating an example performance of blocks 315, 320, and 325 of the method of FIG. 2.

FIG. 6 is a diagram illustrating another example performance of blocks 315, 320, and 325 of the method of FIG. 2.

FIG. 7 is a diagram illustrating a further example performance of blocks 315, 320, and 325 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method including: capturing, via an image sensor of a computing device, a first image in a frame sequence using a first autofocus region having a first position; detecting a region of interest having a second position in the image, the region of interest containing a barcode; in response to receiving, at an autofocus controller, a failure to decode the region of interest, generating, by the autofocus controller, a second autofocus region based on the second position of the region of interest in the image, the second autofocus region configured for capturing a second image in the frame sequence via the image sensor.

Additional examples disclosed herein are directed to a computing device, comprising: an image sensor; and a processor configured to: capture, via the image sensor, a first image in a frame sequence using a first autofocus region having a first position; detect a region of interest having a second position in the image, the region of interest containing a barcode; in response to receiving a failure to decode the region of interest at a barcode decoder, generate a second autofocus region based on the second position of the region of interest in the image, the second autofocus region configured for capturing a second image in the frame sequence via the image sensor.

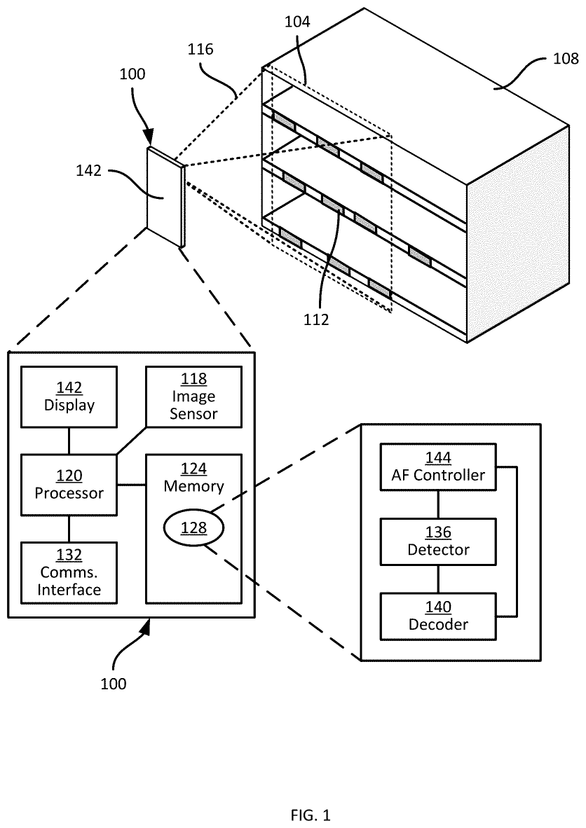

FIG. 1 illustrates a computing device 100, such as a mobile computer, a smart phone, a barcode scanner, an imaging device mounted on a chassis of an autonomous or semi-autonomous apparatus, or the like. The device 100 includes a housing supporting various components of the device 100, discussed below. The device 100 can be operated to capture images, and is configured to detect barcodes within such images and to decode the detected barcodes. In the discussion below, the term “barcode” includes symbols using one-dimensional symbologies that encode data horizontally (e.g., UPC-A, Code 128, and the like), and symbols with two-dimensional symbologies (e.g., Data Matrix, QR Code, DotCode, and the like).

For example, the device 100 can be operated to capture an image representing a region 104 of a shelf or other support structure 108 that supports one or more barcodes 112 (illustrated as grey boxes in FIG. 1). In the illustrated example, the support structure 108 includes shelves, and the barcodes 112 are disposed on shelf edges, e.g., facing into an aisle of a facility in which the device 100 is deployed. A wide variety of other objects, or collections of objects, can carry the barcodes 112 in other examples. For example, the barcodes 112 can be affixed to packages in a sorting facility, on products on the support structure 108, or the like. In other examples the barcodes can be presented on a sheet, e.g., listing a set of items in a pallet or other aggregation of inventory. Such a sheet may therefore include a grid or list of numerous barcodes.

The region 104 of the support structure 108 contains nine barcodes 112 in the illustrated example, although it will be understood that other images captured by the device 100 may encompass larger or smaller numbers of barcodes 112. The barcodes 112 appear at various positions within the region 104 of the support structure 108. The extent of the region 104 is determined by a field of view (FOV) 116 of an image sensor 118 of the device 100 (e.g., a camera).

The image sensor 118 can be supported by a housing of the device 100, along with various other components of the device 100, including a processor 120, such as a central processing unit (CPU), graphics processing unit (GPU), application-specific integrated circuit (ASIC), or the like. The processor 120 is communicatively coupled with a non-transitory computer-readable storage medium such as a memory 124, e.g., a combination of volatile memory elements (e.g., random access memory (RAM)) and non-volatile memory elements (e.g., flash memory or the like). The memory 124 stores a plurality of computer-readable instructions in the form of applications, including in the illustrated example a barcode detection application 128, whose execution by the processor 120 configures the device 100 to process images captured via the sensor 118 to detect and/or decode barcodes 112 therein.

The device 100 can also include a communications interface 132, enabling the device 100 to communicate with other computing devices (not shown) via any suitable communications links. The device 100 can also include one or more output devices, such as a display 142 (e.g., disposed on an opposite side of the device 100 from the sensor 118), a speaker (not shown), or the like. In other examples, the display 142 can be omitted, e.g., in the case of a barcode scanner with a ring form factor, implementations where the device 100 is a component of an autonomously-navigating apparatus, or the like. The device 100 can further include one or more input devices, such as a microphone, a touch screen (e.g., integrated with the display 142), a keypad, a scan trigger, or the like.

The device 100 implements, for example via the application 128, a detector 136 configured to process images captured via the sensor 118 to detect regions of interest therein containing barcodes, and a decoder 140 configured to process the regions of interest from the detector 136 to decode the barcodes contained in the regions of interest. The device 100 also implements an autofocus (AF) controller 144, e.g., via the application 128. The AF controller 144, as discussed below, can interact with the detector 136 and the decoder 140, and can modify certain settings used by the image sensor 118 to capture images.

In the illustrated example, the detector 136, the decoder 140, and the AF controller 144 are implemented by the processor 120 via execution of the application 128. In other examples, however, one or more of the detector 136, the decoder 140, and the AF controller 144 can be implemented in distinct hardware elements, via separate applications, and the like. For example, the processor 120 can implement the detector 136 and the AF controller 144 via execution of the application 128, and the device 100 can include additional control hardware or other processing hardware implementing the decoder 140, such as a scan engine. In further examples, the processor 120 can implement the AF controller 144 via execution of the application 128, while the detector 136 and the decoder 140 can be implemented via an additional controller or other processing hardware, such as the above-mentioned scan engine.

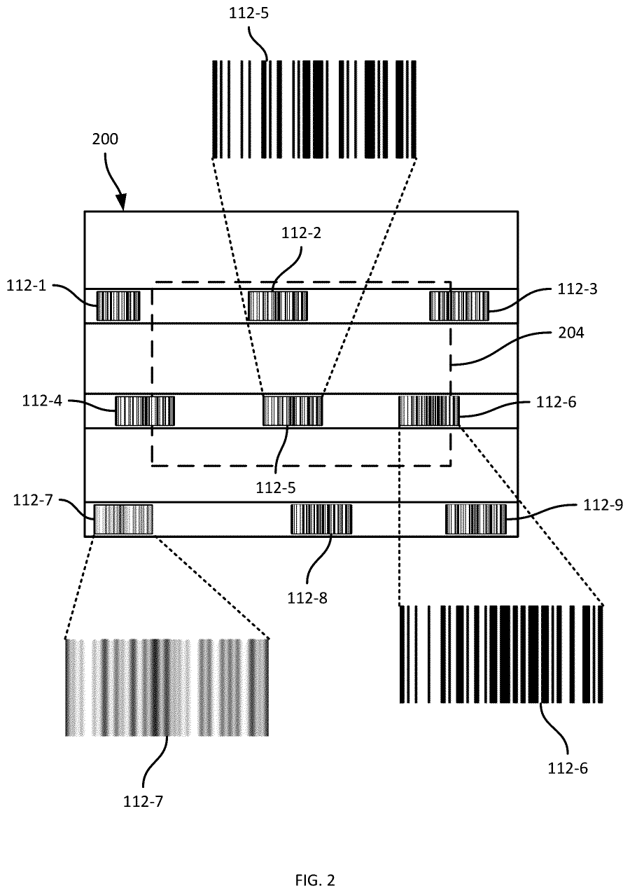

Referring to FIG. 2, an example image 200 captured by the sensor 118 and depicting the region 104 of the support structure 108 is illustrated. The image 200 contains the barcodes 112 mentioned in connection with FIG. 1, and referred to individually in FIG. 2 as barcodes 112-1, 112-2, 112-3, 112-4, 112-5, 112-6, 112-7, 112-8, and 112-9. The sensor 118 can be configured to capture images with a first AF region 204.

As will be understood by those skilled in the art, image sensors may sample data at various points throughout the FOV 116 (also referred to as AF points). For example, the sensor 118 can be configured to assess contrast gradients at those points, and adjust lens positions and/or other configuration settings of the sensor 118 to maximize such contrast gradients and thereby place the objects within the FOV 116 in focus. The AF region 204 represents a region within which AF points are given greater weight in the above-mentioned adjustments. For example, the sensor 118 can be configured to adjust the above settings to maximize an average contrast gradient observed across any AF points within the region 204. AF points outside the region 204 may contribute less, or not at all, to the adjustment of camera settings. As a result, certain barcodes, such as the barcodes 112-5 and 112-6 which fall within the first AF region 204, are in focus in the image 200, while other barcodes 112, such as the barcode 112-7, are out of focus, and therefore blurry as shown in FIG. 2. For a default AF region 204 centered within the FOV 116, and occupying for example about 75% of the FOV 116, barcodes 112 near the outer edges of the FOV 116 (such as the barcodes 112-7, 112-8, and 112-9) may be less in focus than barcodes 112 closer to the center of the FOV 116. In some cases, decoding of such barcodes 112 may fail, due to the lower fidelity with which those barcodes 112 are represented in the image 200.

When decoding fails for one or more of the barcodes 112, the device 100 may be controlled (e.g., by an operator of the device 100 or the like) to capture additional images, and repeat attempts to detect and decode the barcodes 112. However, repeated decode attempts may also fail, as certain barcodes 112 may remain out of focus. The capture and processing of at least some of the additional images may therefore be an inefficient deployment of computational resources at the device, yielding little or no results beyond the partial decode results from the image 200.

As discussed below, the device 100 is configured, e.g., via the AF controller 144, to implement dynamic AF control for additional image captures, to reduce the number of capture attempts to successfully decode the barcodes 112, including those for which decoding initially failed.

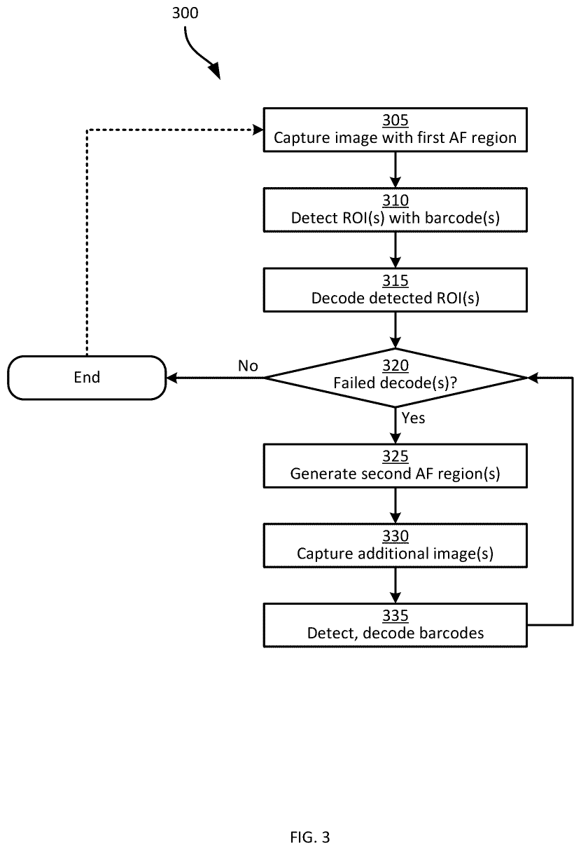

Turning to FIG. 3, a method 300 of dynamic autofocus control for image-based barcode decoding is illustrated. The method 300 is described below in conjunction with its performance at the device 100, e.g., via execution of the application 128 by the processor 120.

At block 305, the device 100 is configured to capture an image (e.g., the image 200 shown in FIG. 2) with the AF region 204 mentioned above. For example, the processor 120 can transmit a capture command to the sensor 118, and the sensor 118 can apply the AF region 204 as a default autofocus control. The capture command can include a command to capture a single image frame, or to initiate capture of a sequence of image frames, e.g., in a continuous or video capture mode, at a suitable frame rate (e.g., 10 frames per second, although both slower and faster capture rates may be employed, depending on the capabilities of the sensor 118 and the computational resources available to process the captured images).

In this example, At block 310, the device 100 is configured to detect one or more regions of interest (ROI) in the image from block 305. For example, the detector 136 can be configured to detect areas in the image with vertical gradients indicating the presence of a barcode. As will be apparent to those skilled in the art, various other mechanisms can be employed to detect the positions of barcodes in the image 200. In some examples, the detector 136 can implement a machine-learning based classifier, trained to detect barcodes of various symbologies and return the positions of likely barcodes (e.g., regardless of symbology). The detector 136 produces, at block 310, one or more positions such as bounding boxes defined in image coordinates (e.g., coordinates corresponding to the sensor 118, or that can be mapped to sensor coordinates via calibration data of the sensor 118).

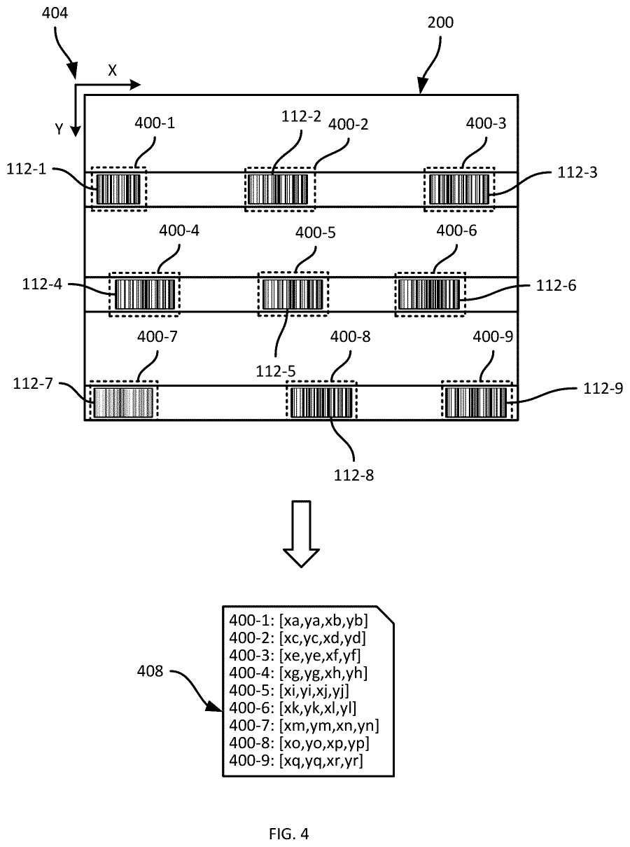

FIG. 4 illustrates an example set of ROIs 400-1, 400-2, 400-3, 400-4, 400-5, 400-6, 400-7, 400-8, and 400-9 corresponding to the barcodes 112. Each ROI 400, in this example, is a rectangular bounding box which may be defined by pixel coordinates (e.g., according to a coordinate system 404) of each corner, coordinates of the upper-left corner and lower-right corner, or the like. The device 100 can be configured to store the ROIs 400, e.g., in a list 408 or other data structure in the memory 124, with each ROI 400 being defined in the list 408 by an identifier (e.g., “400-1”) and a set of coordinates.

Returning to FIG. 3, at block 315 the device 100 is configured to decode (or attempt to decode) the ROIs 400 from block 310. For example, the detector 136 can be configured to provide the image 200 and the coordinates of each ROI 400 to the decoder 140. In other examples, the detector 136 can extract portions of the image 200 corresponding to each ROI 400, and provide the extracted portions to the decoder 140. The decoder 140 is configured to process the image (or the extracted portions, as applicable) to decode each ROI 400. A wide variety of decoding mechanisms will occur to those skilled in the art for implementation by the decoder 140. The decoder 140 is configured to generate, e.g., for provision to the AF controller 144, a set of decode results. The decode results include, for each ROI identifier, either a decoded value, or an indication that decoding the corresponding ROI 400 failed. The decode results can also include other information, such as the symbology of the barcode 112 in the corresponding ROI 400.

At block 320, the device 100 is configured to determine whether any of the barcodes 112 in the ROIs 400 were not decoded at block 315. When the determination at block 320 is negative, indicating no failed decodes, the performance of the method 300 can end. For example, as indicated by the dashed line from the “End” block to block 305, the device 100 may return to block 305 to process the next image, e.g., when operating in a continuous capture mode.

When the determination at block 320 is affirmative, indicating that at least one of the ROIs 400 detected at block 310 was not successfully decoded at block 315, the device 100 proceeds to block 325. At block 325, the device 100, e.g., the AF controller 144, is configured to generate at least one secondary AF region, based on the position(s) of the ROI(s) 400 for which decoding at block 315 failed.

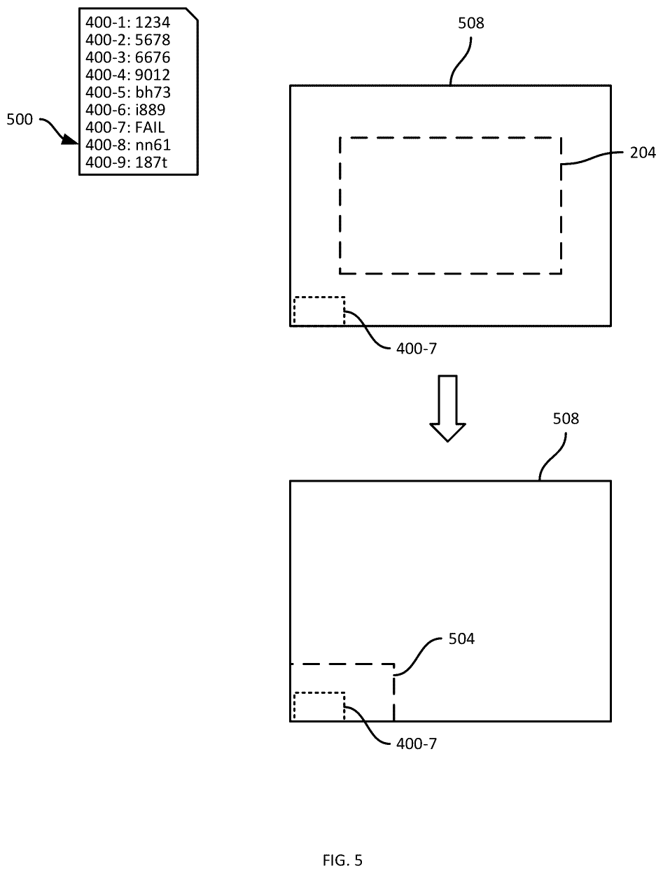

Turning to FIG. 5, a set of decode results 500 is illustrated, e.g., received at the AF controller 144 from the decoder 140. As seen in FIG. 5, the results 500 include decoded values for each ROI 400 except the ROI 400-7, which failed to decode. At block 325, the AF controller 144 is configured to generate a second AF region 504, based on the coordinates defining the ROI 400-7 (e.g., retrieved from the list 408 based on the ROI identifier 400-7 in the results 500). The second AF region 504, illustrated in FIG. 5 relative to the full pixel array 508 of the sensor 118 in comparison to the AF region 204, can be generated in a variety of ways.

In the example of FIG. 5, the second AF region 504 has a width equal to twice the width of the ROI 400-7, and a height equal to twice the height of the ROI 400-7. In other examples, the AF region 504 has the same dimensions as the ROI 400-7. The AF region 504 can also be larger than shown in FIG. 5, relative to the ROI 400-7. The AF region 504, however, is generally smaller than the default AF region 204, to reduce the likelihood that averaging of camera settings to optimize focus over a larger portion of the array 508 will lead to the ROI 400-7 being out of focus again in a subsequent image capture.

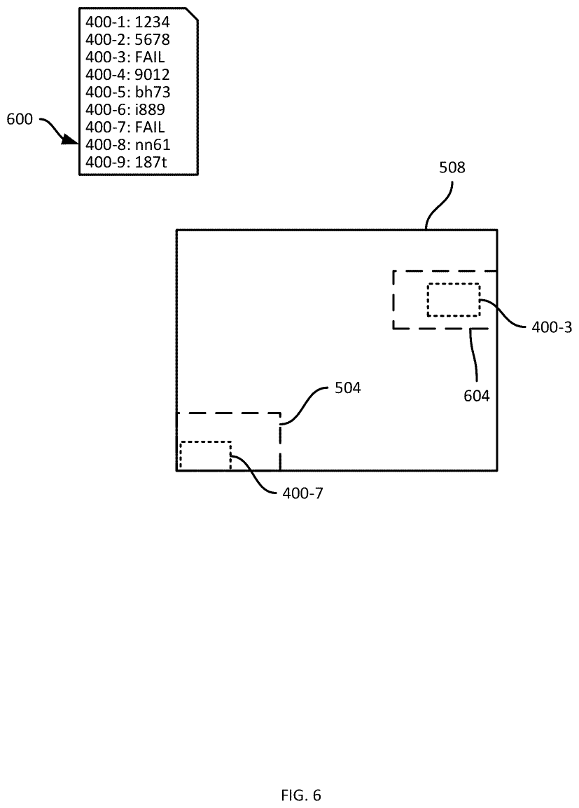

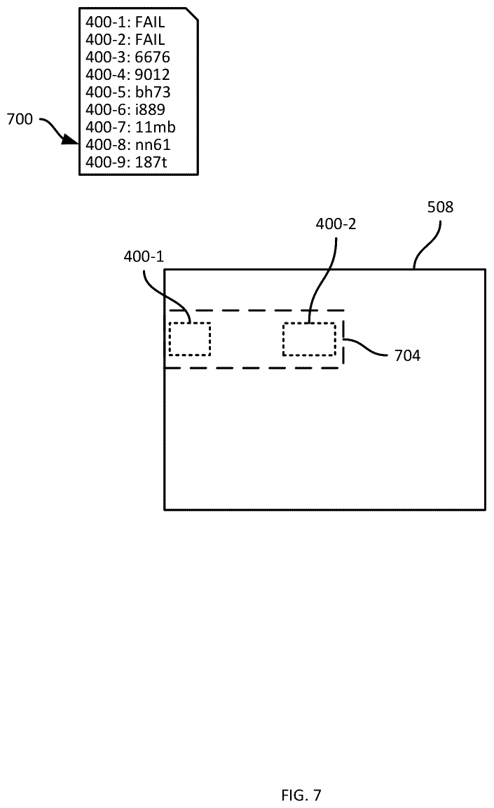

Turning to FIG. 6, in some examples the device 100 can generate more than one AF region at block 320, e.g., when more than one ROI 400 fails to decode. For example, as shown in FIG. 6, example decode results 600 indicate that the ROIs 400-3 and 400-7 failed to decode. The device 100 can then generate the AF region 504 and a further AF region 604, based respectively on the positions of the ROIs 400-7 and 400-3. In further examples, as shown in FIG. 7, in which decode results 700 indicate that the ROIs 400-1 and 400-2 failed to decode, the device 100 can generate a combined AF region 704 based on the positions of both the ROIs 400-1 and 400-2. For example, the device 100 can determine whether the failed ROIs 400 are within a threshold distance of one another (e.g., a pixel distance, a fraction of the image width and/or height, or the like), and when the failed ROIs are sufficiently close, the device 100 can generate a combined AF region. Otherwise, the device 100 can generate distinct AF regions, as shown in FIG. 6.

Returning to FIG. 2, at block 330 the device 100 is configured to capture one or more additional images, using the AF region(s) generated at block 325. If a single AF region was generated at block 325 (e.g., as in FIG. 5 or FIG. 7), the device 100 can be configured to capture one image, using the single AF region (e.g., the AF region 504 or 704). The processor 120 can, for example, transmit a capture command to the sensor 118 with an AF region parameter indicating the coordinates of the AF region from block 325, to override the default AF region 504. When the device 100 generated more than one AF region at block 325, as shown in FIG. 6, at block 330 the processor 120 can transmit one capture command to the sensor 118 including each AF region, e.g., in embodiments in which the sensor 118 is capable of applying multiple AF regions in one capture operation. In other examples, in which the sensor 118 can apply only one AF region per capture operation, the processor 120 can transmit a sequence of capture commands to the sensor 118, each containing one of the AF regions from block 325.

At block 335, in response to capturing one or more additional images at block 330, the device 100 is configured to detect and decode ROIs in the additional image(s) from block 330. The detection of ROIs and the decoding of barcodes from the detected ROIs can be performed substantially as described above in connection with blocks 310 and 315. In some examples, however, the device 100 can be configured to pass ROIs to the decoder 140 only if those ROIs have positions substantially matching the positions of ROIs that previously failed to be decoded. For example, the device 100 can store the ROIs 400, e.g., in association with the decode results 500, and compare any newly detected ROIs to the ROIs 400. Any newly detected ROI at block 335 with a position substantially equal (e.g., overlapping at least half) to a previously successfully decoded ROI 400 can be omitted from the set of ROIs passed to the decoder 140.

In response to detecting ROIs and decoding barcodes from those ROIs at block 335, the device 100 can return to block 320, to determine whether any ROIs remain to be decoded (e.g., whether any ROIs failed to decode in the image(s) captured at block 330). The decode results from block 335 can be added to the decode results from block 315, and therefore even if, for example, the ROI 400-5 fails to be decoded at block 335, the ROI 400-5 was previously decoded at block 315, and does not cause an affirmative determination at block 320.

When the determination at block 320 is negative, as noted earlier, the performance of the method 300 ends. The processor 120 can, for example if the sensor 118 is operating in a continuous capture mode, send an updated capture command to the sensor 118 that reverts the AF region to the default AF region 204.

As will now be apparent, implementing some or all of the functionality described at the device 100 may enable the device 100 to detect and successfully decode a plurality of barcodes within the FOV 116 with fewer image captures. Dynamically controlling the AF region(s) used by the sensor 118 based on previously failed decode operations may increase the likelihood that the same barcodes will be successfully decoded in subsequent image captures.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
capturing, via an image sensor of a computing device, a first image in a frame sequence using a first autofocus region having a first position;
detecting a region of interest having a second position in the image, the region of interest containing a barcode;
in response to receiving, at an autofocus controller, a failure to decode the region of interest, generating, by the autofocus controller, a second autofocus region based on the second position of the region of interest in the image, the second autofocus region configured for capturing a second image in the frame sequence via the image sensor.

2. The method of claim 1, further comprising:
detecting an additional region of interest in the first image, the additional region of interest containing an additional barcode; and
in response to receiving, at the autofocus controller, a failure to decode the region of interest and the additional region of interest, generating the second autofocus region based on the positions of the region of interest and the additional region of interest.

3. The method of claim 1, further comprising:
detecting an additional region of interest in the first image, the additional region of interest containing an additional barcode; and
in response to receiving, at the autofocus controller, a failure to decode the region of interest and the additional region of interest, generating the second autofocus region and a third autofocus region based on a position of the additional region of interest.

4. The method of claim 3, further comprising:
capturing a third image using the third autofocus region, in sequence with capture of the second image.

5. The method of claim 1, wherein the second autofocus region has a smaller area than the first autofocus region.

6. A computing device, comprising:
an image sensor; and
a processor configured to:
capture, via the image sensor, a first image in a frame sequence using a first autofocus region having a first position;
detect a region of interest having a second position in the image, the region of interest containing a barcode;
in response to receiving a failure to decode the region of interest, generate a second autofocus region based on the second position of the region of interest in the image, the second autofocus region configured for capturing a second image in the frame sequence via the image sensor.

7. The computing device of claim 6, wherein the processor is configured to:
detect an additional region of interest in the first image, the additional region of interest containing an additional barcode; and
in response to a failure to decode the region of interest and the additional region of interest, generate the second autofocus region based on the positions of the region of interest and the additional region of interest.

8. The computing device of claim 6, wherein the processor is configured to:
detect an additional region of interest in the first image, the additional region of interest containing an additional barcode; and
in response to a failure to decode the region of interest and the additional region of interest, generate the second autofocus region and a third autofocus region based on a position of the additional region of interest.

9. The computing device of claim 8, wherein the processor is configured to:
capture a third image using the third autofocus region, in sequence with capture of the second image.

10. The computing device of claim 6, wherein the second autofocus region has a smaller area than the first autofocus region.
